(19) United States
(12) Patent Application Publication
(10) Pub. No.: US 2009/0280345 A1
(43) Pub. Date: Nov. 12, 2009

(54) COMPOSITIONS FOR USE IN TREATING ORGANIC SUBSTANCES

(75) Inventors: Paul Nigel Maynard, Auckland (NZ); Anthony John Bergervoet, Waiuku (NZ)

Correspondence Address: OCCHIUTI ROHLICEK & TSAO, LLP, 10 FAWCETT STREET, CAMBRIDGE, MA, 02138, US

(73) Assignee: Mattersmiths Holdings Limited, Auckland (NZ)

(21) Appl. No.: 11/816,793

(22) PCT Filed: Feb. 22, 2006
(86) PCT No.: PCT/NZ2006/000027

§ 371 Date: Mar. 11, 2009

(30) Foreign Application Priority Data
Feb. 22, 2005 (NZ) 538446
Jun. 17, 2005 (NZ) 540854
Feb. 2, 2006 (NZ) 545116

(51) Int. Cl. B27K 3/12; B32B 21/00; B27K 3/34

(52) U.S. Cl. 428/541; 427/553; 106/287.26

(57) ABSTRACT

This application is directed to compositions for use in treating organic substrates, in particular lignocellulosic substrates. The composition comprises water, a water miscible solvent and an organic substrate treatment compound such as biocides. The application also relates to methods of delivering treatment compositions to the substrate. The methods may be for the purpose of prevention of growth of pest organisms, or for providing specific properties to the substrate for example.

### FIELD

This invention relates to compositions for use in treating organic substrates and to methods of delivering compositions to organic substrates. In particular, the invention relates to compositions for, and methods of, delivering treatment compounds to lignocellulosic substrates, such as lumber. The methods may be for the purpose of prevention of growth of pest organisms, or for providing specific properties to the substrate, for example.

### BACKGROUND

Lumber from many tree species lacks durability and frequently has inferior physical properties. These deficiencies are more likely to occur in lumber extracted from man-made plantation forests. Since durability and enhanced physical properties can be required it is typical for lumber processors to alter lumber properties.

It is well known to those versed in the art that these deficiencies can be remedied to a greater or lesser extent by impregnation of the lumber with preservatives, polymers and the like. Such impregnation processes have been used for many decades and most frequently involves impregnation with treating fluids.

A relatively modern trend is to treat lumber in its final ready to use form. This eliminates any contaminated waste streams (saw dust, shavings and the like) which would otherwise occur during subsequent processing of lumber treated in crude form.

When treating lumber it is preferable to have the lumber already dry, that is, with its cells empty. This is because space is required for the incoming treating fluid.

Typically lumber is treated with either waterborne preservatives, or with solvent fluids based on non-polar organic solvents such as white spirits (LOSP processes). Both processes are similar in that variations of vacuum and pressure are used.

A deficiency of known waterborne processes is that substantial uptakes are required to achieve full penetration. This in part is due to rewetting of the cell wall and to adsorption of water into or onto the cell wall. Thus to overcome this adsorption and ensure full penetration, uptakes can vary from 150 litres per cubic metre to 600 litres per cubic metre depending on the process used, Current treatment methods with waterborne solutions causes swelling which is undesirable. Once treated, the lumber must be redried and this is costly. However waterborne processes do enable use of inexpensive well proven inorganic biocides.

A significant issue arises using waterborne processes. Because the preservatives are necessarily soluble in water, they remain mobile for some time subsequent to treatment. That is they offer the potential for elution into the environment when in contact with ground water or when exposed to rain, with the potential hazard that it might create. Modern processes can use a heating step wherein the interaction between the preservatives and the wood is hastened. This is time consuming, requires additional plant and a means of energy to raise the substrate temperature, and because the heat source is typically steam or hot water, waste streams contaminated with heavy metals result.

LOSP processes using non-polar organic solvents overcome the swelling problem and have quite low uptakes of around 30 to 40 litres per cubic metre. This is because there is no significant interaction between the solvent and the cell wall. That is, the solvent is non-polar and does not interact with or adsorb onto cellulose or lignin, which are polar. Uptakes can be as low as 30 to 50 litres per cubic metre. Drying in the normal sense is not required although the solvent must be allowed to evaporate. Whilst this process is effective for treating dry lumber the cost of solvent is high and eventually all the solvent escapes into the atmosphere thus becoming an environmental issue. Further, the solvent is manufactured from petroleum feedstocks thus it is not a renewable resource and is subject to significant price variations. However in favour of LOSP is the option to recover and recycle the solvent.

A major deficiency of LOSP processes is that they must use non-polar solvent soluble biocide systems. These are typically very expensive including the likes of, for example, complex triazoles and synthetic pyrethroids and which require expensive solvents or formulating techniques. Also typically used are Tri Butyl Tin compounds which are environmental poisons.

Many processes are known for the impregnation of lumber. These processes are adequately described in “Industrial Timber Preservation”, 1979, J G Wilkinson, Associated Business Press.

Several such processes include those of: 1) Rueping: Pre-pressure with gas followed by pressure with preservative or chemical solution; 2) Lowry: Pressure impregnation with preservative or chemical solution; and 3) Bethel: Vacuum followed by pressure impregnation with preservative or chemical solution.

The Rueping process applies pre-pressure with gas prior to treatment with preservative fluids. This pre-pressure with gas fills the cells with a compressible medium such that after treatment with fluid the gas will expand forcing out any surplus fluid. However this can result in ongoing kickback of preservative contaminated fluid which may be hazardous and which kickback fluid may contain extractives which will interfere with preservative chemistry.

The Rueping and Lowry processes retain gas within the void spaces within the substrate. Thus, the impregnation process requires pumps to force fluid into the substrate against the back pressure of the gases in the voids.

The Bethel process removes all gases from the cells by application of a vacuum which cells then become completely filled with preservative fluid. When using aqueous fluid this method has the disadvantage that lumber is completely filled which cannot be sucked out again. Accordingly, the lumber takes considerable time to dry.

Another process is that described in WO 2004/054765 which involves irradiation of the substrate causing bound water to turn into vapour thus creating voids in the cells.

LOSP preservatives use a solvent known as a Stoddard solvent, otherwise commonly known as aliphatic white spirits or mineral spirits. The modern versions of this are refined to remove aromatic compounds to improve odour and reduce toxicity. Moreover, impregnation processes used to apply LOSP formulations have been developed and refined to limit the amount of solvent transferred to the wood whilst ensuring substantial penetration. An example of this would be the “Double-Vacuum” process, wherein the wood is evacuated and then flooded with preservative, the vacuum is released to atmospheric pressure for a short time, then the preservative is transferred away from the wood and a second vacuum is applied to remove excess preservative.

Despite these improvements costs continue to escalate and because of environmental concerns there is a growing trend away from products using LOSP preservatives. However because redrying of the substrate is not required there still exists a potential market, particularly if any residual solvent could be recovered and recycled.

Researchers and practitioners have looked at many solvents and their interactions with wood. Generally highly polar solvents such as water and methanol interact strongly with wood, absorbing into and onto the cell wall and causing swelling. Non-polar solvents such as white spirits and the like cause no swelling. Similarly the likes of xylene, petroleum ether, ketones such as cyclohexanone, methylene chloride, trichloroethane do not produce swelling. These are typically immiscible in water. Polar solvents for example, methanol do readily penetrate lumber but these can have a negative impact on swelling.

White spirits are highly flammable and therefore appropriate plant design and operating procedures must be used to minimise potential adverse consequences, Alternative organic solvents are available but since these are either costly or toxic they do not present a viable economic option. The simple alcohols such as methanol and ethanol are relatively economical but have higher flammability than white spirits so have not been used commercially. Methanol is also toxic and is known to cause significant swelling of lumber.

U.S. Pat. No. 5,871,817 teaches the use of “a liquid boron based preservative formulation formed by mixing boric acid or boron oxide with one or more solvents selected from the group consisting of methanol and ethanol without removing any reaction by-products from the mixture”. Such mixtures will form and contain some proportion of reactive compounds, particularly methyl and ethyl borate esters. Such reactive compounds, which are both volatile and reactive toward water or moisture as described in U.S. Pat. No. 5,871,817, provide the basis for working of that patent, In that they will readily penetrate dried wood, and will react with residual moisture in that wood.

Whilst the invention of U.S. Pat. No. 5,871,817 may offer an alternative to the user a major problem exists in that the Interaction of boron compounds with the alcohol can continue after application to the substrate, In certain circumstances this can result in emission of flammable and toxic organoboron compounds. This volatility precludes any attempts to extract any residual solvent by either vacuum or RF assisted vacuum processes, because these processes will immediately withdraw organoboron compounds as well.

Because lumber must have substantial voids within which the preservative can be transferred, whether for waterborne preservatives or LOSP preservatives, the lumber must be substantially dry. LOSP preservative processes dictate that the lumber must be dried to its final moisture content, that is, around twelve to fifteen percent on a mass basis.

Lumber for waterborne processes can have greater moisture content, that is, above fibre saturation (around thirty percent). Thus whilst LOSP treated lumber is still “dry” after treatment and requires no redrying in the traditional sense, it is still an expensive process because it wastes significant volumes of solvents (VOC's—volatile organic compounds). The waterborne process allows for higher pre-treatment moisture content but still suffers the expensive redrying process.

Modern drying practices frequently use high temperature processes. These use substantial energy from large boilers, Energy is supplied to the lumber in a fast moving hot air flow. Because each piece of lumber must be surrounded by this hot air flow there must be spaces between each piece. Because the high energies cause distortion of the lumber the lumber is constrained by large heavy weights. This means that kilns have quite limited capacity despite high initial void volume. High temperature drying processes can be very rapid but due to significant variability in moisture content occurring between pieces of lumber, a reconditioning process is applied. This requires drying to substantially below the final desired moisture content, perhaps six to eight percent, followed by readmission of moisture to facilitate equilibration. This means that substantially higher energy is used much of which is finally wasted. Shrinkage and distortion can be a significant problem.

Conventional drying to fibre saturation point is primarily a mass flow mechanism and both time and energy used are relatively low. However below fibre saturation, energy costs escalate rapidly because not only is energy slow to move into the lumber due to insulation effects, the removal of bound water requires more energy also. Thus energy losses to the environment increase due to the lower efficiency of equipment when drying below fibre saturation. In addition, both the energy and time required to achieve final moisture content is substantially more below fibre saturation. Further, it is during this period that most of the stress is created within the lumber.

Whilst the initial phases of drying of organic substrates, including lumber, involves mass flow, much water is bound to the substrate. This can be exemplified in the retained water below fibre saturation in dried lumber. RF energy can be applied to organic substrates including lumber, and this RF energy impacts directly with, and can be absorbed by, the bound water. Because RF energy can penetrate readily throughout the substrate, energy flow is rapid. However the absorption of RF energy depends on a material or compound within the substrate having the ability to absorb that energy. The property implicit in this process is called dielectric loss. Materials with low dielectric loss, such as the Stoddard solvents used in traditional LOSP solvent systems, will absorb little energy whereas a material with high dielectric loss, such as water, highly polar solvents such as DMSO, N-methyl pyrrolidone and the like or glycols such as ethylene or propylene glycol or glycerol, will readily absorb the energy. It is also important to consider the effects on the substrate if that substrate is already substantially dry. For example if the lumber prior to treatment is at equilibrium moisture content, say between 12 and 15 percent, RF heating will reduce the moisture content further. This could cause shrinkage, possibly checking, and if not controlled can cause degradation of appearance and strength.

It is well known by those versed in the art that preservatives require time to fix to the treated substrate. This is particularly so for preservatives containing hexavalent chromium or copper amine systems. It is also known that fixation rates can be enhanced by increasing temperature; however certain conditions must be taken into account. For example fixation of hexavalent chromium containing systems must be maintained at high humidity otherwise the reaction alters and this can result in reduced lumber strength or a decrease in preservative performance. With copper amine systems higher temperatures can result in a reduction of the oxidation state of copper thus reducing bio-efficacy, and can also result in significant darkening of wood colour which is not desirable.

### OBJECT

It is an object of the present invention to provide a composition and method for delivery of a composition to organic substrates, particularly lignocellulosic substrates, or at least to provide the public with a useful choice.

### STATEMENT OF INVENTION

In a first broad aspect, the present invention provides an organic substrate treatment composition including:
water;
a volatile water miscible solvent; and
an organic substrate treatment compound.

Preferably, the organic substrate is lignocellulosic.

Preferably, the lignocellulosic substrate is lumber.

Preferably, the volatile water miscible solvent is a volatile water miscible organic solvent.

Preferably, the volatile water miscible organic solvent is readily recoverable by vacuum condensation methods.

Preferably, the volatile water miscible organic solvent is a low molecular weight alcohol, ketone, ether or diether.

Preferably, the volatile water miscible organic solvent is selected from one or more of methanol, ethanol, ethyleneglycol monomethyl ether, ethylene glycol dimethyl ether or diethylene glycol dimethyl ether.

More preferably, the water miscible organic solvent is methanol or ethanol.

Most preferably, the water miscible organic solvent is ethanol.

Preferably, the ratio of water:solvent is at about 4:96.

Preferably, the ratio of water:solvent is at least 20:80, more preferably up to 25:75 and more preferably up to about 50:50.

Preferably, the water:alcohol ratio is about 25:75.

Preferably, the organic substrate treatment compound is a biocide.

Preferably, the biocide is an organic or inorganic biocide or a combination thereof.

Preferably, the organic substrate treatment compound alters the physical properties of the substrate.

Preferably, the organic substrate treatment compound is selected from resins or polymers or components which can become resins or polymers.

Preferably said resins or polymers are reacted or polymerised subsequent to the impregnation process.

Preferably said resins or polymers are reacted during a subsequent RF vacuum solvent recovery schedule

Preferably, the organic substrate treatment compound is non-volatile.

Preferably, the composition further includes dyes, pigments, water repellents, fire retardants and the like.

Preferably, the organic substrate treatment compound is an amine copper complex.

Preferably, the amine copper complex is formed using an alkanolamine as the amine complexing agent.

Preferably, the alkanolamine is monoethanolamine, diethanolamine, triethanolamine or propanolamine.

Preferably, the organic substrate treatment compound is an azole or mixture of azoles

Preferably, the organic substrate treatment compound is an azole or mixture of azoles and an amine copper complex.

Preferably, the organic substrate is substantially dry lumber that is at or below fibre saturation.

Preferably the organic substrate is slightly above fibre saturation.

Preferably, the composition includes a fire retardant.

Preferably, the fire retardant is in combination with a biocide.

Preferably, the composition is an emulsion or micro-emulsion.

Preferably if one component is Incompatible with another component, one or other component can be micro-encapsulated and then combined with the other.

The invention also relates to a process for treating an organic substrate wherein the composition as described in the first aspect of the invention above is applied to the substrate by dipping, spraying or vacuum pressure impregnation and optionally includes use of the treatment process described in WO 2004/054765.

Preferably, residual solvent from the composition is allowed to evaporate from the substrate.

Preferably, removal of the residual solvent from the substrate is enhanced by the use of radio frequency (RF) exposure.

Preferably, solvent removed from the substrate is recovered.

Preferably, solvent recovery includes use of vacuum condensation.

Preferably, the aqueous solvent system contains 50% or more of water.

Preferably, the composition is applied to the substrate by dipping, deluging, spraying, or brushing. Additionally, variations of vacuum or positive pressure impregnation may be used.

Preferably, the composition is applied at between ambient temperature and 100 Celsius.

Preferably, the composition is applied at ambient temperature.

Preferably, the composition is applied to the substrate using vacuum pressure impregnation, following which the solvent is allowed to evaporate from the substrate.

Preferably, the composition is applied to the substrate using a single vacuum impregnation, following which the solvent is allowed to evaporate from the substrate.

Preferably, the solvent is encouraged to evaporate using RF energy and the emitted solvent recovered by condensation.

Preferably, when the organic substrate includes water additional to solvent water, this is also encouraged to evaporate using RF energy.

Preferably when preservatives requiring fixation are used, fixation is enhanced during a solvent recovery process.

Preferably, the amount of moisture removed during the recovery step is substantially the same as that moisture applied during the treatment.

Preferably, recovery of evaporated solvent may be assisted by use of a vacuum in a drying type process.

Preferably, the composition is applied to the substrate which is at or below fibre saturation.

Preferably, the composition is applied to the substrate which is above fibre saturation.

Preferably, the solvent recovery step achieves an increase in temperature in the substrate.

Preferably, the increase in temperature in the substrate as a result of the solvent recovery step improves fixation of the biocides conveyed into the substrate by the composition.

Preferably, any swell imparted to the substrate is at least minimised by the solvent recovery process

In another aspect, of the invention, the invention provides an organic substrate treatment composition including water plus a solvent selected from low molecular weight alcohols, ketones, glycol ethers and glycol diethers, together with an organic treatment compound.

Preferably, the organic substrate treatment compound is a biocidal composition.

Preferably, the organic substrate treatment compound is one which may impart properties of higher density or strength to at least a target zone of the substrate.

Preferably, the organic substrate treatment compound is of a polymeric or pre-polymeric nature.

In another aspect, the invention provides a method of preparing a composition for timber treatment, wherein the composition includes an active timber treatment compound, and wherein the method includes the use of a solvent system for the timber treatment compound which includes a combination of a water miscible solvent and water.

Preferably, the ratio of water:solvent is at least 4:96.

Preferably, the ratio of water:solvent is at least 20:80, more preferably up to 25:75 and more preferably at least up to about 50:50.

Preferably, the water:alcohol ratio is about 25:75.

Preferably, the water miscible solvent is an alcohol.

Preferably, the solvent system is water or contains primarily water and the solvent is removed using radio frequency exposure and a vacuum.

In another aspect, the invention relates to a method of treating an organic substrate using an organic substrate treatment composition including water and an organic substrate treatment compound, the composition being applied to the substrate by dipping, spraying or vacuum pressure impregnation and optionally includes the treatment process described in WO 2004/054765, and wherein the water is recovered by RF vacuum assisted solvent recovery.

In another broad aspect, the invention provides an organic substrate to which a composition has been delivered in accordance with a method of the invention.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

### FIGURES

These and other aspects of the present invention, which should be considered in all its novel aspects, will become apparent from the following description, which is given by way of example only, with reference to the accompanying Figures, in which:

FIG. 1: illustrates the distribution of a proprietary borate biocide based on triethanolamine borate achieved by use of the water/ethanol composition; and

FIG. 2: illustrates the distribution of ammoniacal copper quaternary biocide achieved by use of the water/ethanol composition;

FIG. 3: illustrates penetration of preservative in a water only solvent (comparative).

FIGS. 4 and 5: illustrate swell recovery over a range of board widths.

FIGS. 6 and 7: illustrate distribution of ACQ using water:acetone and water:1 propanol components.

From these Figures it can be seen that the process of the invention does not compromise the quality of preservation, whilst conferring associated benefits described herein.

### DETAILED DESCRIPTION OF INVENTION

The following is a description of the preferred forms of the present invention given in general terms in relation to the application of the novel method. While the description focuses particularly on the delivery of compositions to lumber or logs, it should be appreciated that the method may be applicable to other organic substrates.

In general terms, the invention relates to compositions and methods of delivering compositions to an organic substrate, preferably a lignocellulosic substrate. The method allows for absorption or impregnation of the organic substrate by a treatment compound without the necessity of employing systems with only non-polar solvents.

The method of the invention may be used to deliver any fluid composition to a substrate that comprises components that are soluble in volatile water miscible solvent/water combinations. The composition is preferably an aqueous/organic solvent solution and has active components which are non-volatile at the temperature of the substrate at the time of application. Where this invention is particularly novel is that it allows use of otherwise traditional organic substrate treatment compounds, such as inorganic biocides or biocide combinations, without substantially rewetting the substrate. Persons of general skill in the art to which the invention relates will no doubt appreciate various compositions that may be applicable to the invention. However, by way of example, where treatment or prevention of infection or pre-infection by pest organisms is desired, compositions (biocide compositions) having pesticidal (fungicidal, bactericidal, insecticidal for example) or preservative properties may be used. Where it is desired that the substrate has increased density or strength properties, compositions containing certain polymeric or pre-polymeric components may be useful. Resins or polymers, or components that can become resins or polymers, can be used. Similarly, compositions may include compounds of use in waterproofing a substrate or providing fire retarding properties. A combination of treatment compounds (e.g. biocide and fire retardant) would provide clearly beneficial properties to the substrate. Additionally, the compositions may contain certain dyes which may be used to colour the substrate. Suitable biocides and polymeric/prepolymeric compounds would be known to the skilled person.

Whilst not wishing to be constrained biocides could include; copper compounds, quaternary ammonium compounds, organo-iodine compounds, triazoles, metal chelates such as oxine copper, boron compounds, insecticides such as synthetic pyrethroids and the like, or mixtures of these. Fire retardants could include phosphorous compounds, guanidine compounds, melamine compounds, boron compounds or mixtures of these. Resins or polymers could include phenol formaldehyde, urea formaldehyde, melamine formaldehyde and the like. In certain instances it might be convenient to combine these such as melamine urea formaldehyde resin in combination with an inorganic or organic phosphorous compound or a boron compound. In certain circumstances a biocide and/or fire retardant might be used wherein the composition comprises an added emulsifier or surfactant to prepare an emulsion in the solvent combination. When the resin or polymer is incompatible with the biocide or fire retardant as in the case of boron compounds in combination with phenol formaldehyde resins, one or other component might be micro-encapsulated and then combined with the other component.

As used herein, “organic substrate” should be taken to mean any organic material which may be in need of delivery of a composition of some nature; for example for the purposes of protection or treatment to prevent or ameliorate growth of pest organisms. Such substrate is preferably lignocellulosic, for example living trees, wood products, lumber or logs. The invention may be applicable to substrates containing a level of moisture, or those which are substantially dry, at or below fibre saturation.

Again, at least in the case of lignocellulosic substrates, those which are “substantially dry” include lumber dried by traditional methods. Such lumber may contain moisture of approximately 1 to approximately 30 percent as a weight proportion of the lumber dry weight. Substantially dry lignocellulosic substrates include lumber which has been processed via kiln drying, RF vacuum drying and the like and may have been milled to a final, or near final product, and may include for example a lumber composite material.

“Pests” or “pest organisms”, as referred to herein, may include any organisms which may infect an organic substrate, such as wood. While the invention is particularly applicable to fungi, pest organisms may also include insects and the like. The fungi and pests will be well known to people skilled in this art.

When used herein, the term “treatment” should be taken in its broadest possible context. It should not be taken to imply that a substrate is treated such that pest organisms are totally removed, although this is preferable. Prevention and amelioration of growth of pest organisms is also encompassed by the invention.

The words “comprise” or “comprises” should be taken to be synonymous with “includes” or “including” unless the context clearly indicates otherwise.

In one preferred embodiment, the method comprises at least the steps of:

applying a composition to a surface of an organic substrate in which the composition comprises at least water plus a volatile water miscible solvent, and the biocide or substrate modifying chemical.

As used herein, a volatile water miscible solvent includes low molecular weight alcohols, low molecular weight ketones, low molecular weight glycol monoethers or low molecular weight glycol diethers. Preferably these could be selected from any one or more of methanol, ethanol, propanol, acetone, ethyleneglycol monomethyl ether, ethylene glycol dimethyl ether or diethylene glycol dimethyl ether.

In a particularly preferred embodiment of the invention, the composition comprises a solvent mixture comprising water plus ethanol.

It will be appreciated that the solvent composition will depend on the physicochemical properties of the biocide(s) included or any other additive included. Depending upon other properties required such as extraction of moisture from the substrate concurrent with applying the biocide(s) and other components, the organic component may be as high as 97 percent of the solvent. When using purely organic biocides the organic component of the solvent might be in the range of 75 to 80 percent or more whereas for primarily inorganic biocide systems the organic component of the solvent might be lower say 5 to 20 percent. It will be appreciated that a balance will be required between the aims of the process; higher organic solvent ratios favour lower residual moisture in the substrate and are also more conducive to dissolution of organic biocides. Higher water content in the solvent system reduces cost and enhances stability of inorganic components of biocides but may increase moisture content further than desired. Similarly higher organic solvent ratios enhance efficiency if and when solvent recovery is applied. Such matters are within the skill and knowledge of the skilled person once armed with the knowledge of the present invention. Once formed the treatment composition may take the form of an emulsion or microemulsion depending on the combination of components contained within the composition. It can also take the form of a micro-encapsulated component or components.

The composition may be applied to a surface of the substrate using any known means of bringing a composition into contact with a material. By way of example, the composition is applied by dipping, deluging, spraying, or brushing. While the inventors do not believe it necessary to apply active pressure to effect delivery of a composition in accordance with the invention, there may be instances where active pressure systems (positive pressure or vacuum) may be used to assist with delivery, Reference is made to the delivery system described in WO 2004/054765 in this regard by way of example.

While the operating temperature of the composition may vary depending on the nature of the substrate treatment compound (e.g. biocide), for example its solubility and the like, the composition is preferably applied at or around ambient temperature. Temperatures of up to 100° C. could be used depending on the components of the composition. Higher temperatures are less preferred due to the potential to lose solvent and possibly treatment compound from the composition before application.

As mentioned hereinbefore, the method of the present invention is applicable to substrates which are substantially dry (i.e. at or below fibre saturation).

In known art, compositions which are water soluble are typically applied as fully aqueous solutions which significantly rewet the substrate. Where this wetting occurs, the subsequent removal of this water is problematic. A novel feature of the present invention is that it provides the choice of preparing otherwise organic solvent insoluble compositions, for example preservative solutions such as those aforementioned, like ammoniacal copper quaternaries (ACQ) or copper azole, for the purpose of controlling or limiting rewetting of the substrate. The treatment compound can be an azole or a mixture of azoles, optionally also including ACQ. Neither the inorganic nor the organic component of the solvent system is not strongly bound to the substrate, and is volatile allowing for removal by evaporation, extraction, or other solvent removal or recovery processes. The organic substrate treatment compound can therefore be an amine copper complex, for example. Preferably, the complex will be formed using an alkanolamine (e.g. monoethanolamine, diethanolamine, triethenolamine, propanolamine) as the amine complexing agent wherein the amine provides ligands to assist solubilisation of transition metal compounds such as those of copper.

Typically LOSP solvents are flammable, however, this property lies within a range acceptable for use in suitably designed plant. Solvents such as methanol and ethanol are more volatile and more flammable. They are therefore not usually acceptable for use and have not been used to displace LOSP solvents because of this. However, the flammability and volatility of these solvents can be reduced by the addition of water. This is because the water effectively hydrates these solvents lowering both volatility and flammability into an acceptable range.

The following tables illustrate the decrease in flash point achievable by dilution of alcohols with water.

Methanol/Water Mixtures

| MeOH Conc. | Freezing Point, | Flash Point, |
|---|---|---|
| Wt. % (Vol. %) | F. (C.) | (TCC) F. (C.) |
| 0 (0) | 32 (0) | No Flash |
| 10 (13) | 20 (−7) | 130 (54) |
| 20 (24) | 0 (−18) | 110 (43) |
| 30 (35) | −15 (−26) | 95 (35) |
| 40 (46) | −40 (−40) | 85 (29) |
| 50 (56) | −65 (−54) | 75 (24) |
| 60 (66) | −95 (−71) | 70 (21) |
| 70 (75) | −215 (<−73) | 60 (16) |
| 80 (83) | −225 (<−73) | 55 (13) |
| 90 (92) | −230 (<−73) | 55 (13) |
| 100 (100) | −145 (<−73) | 55 (13) |

Ethanol/Water Mixtures

| EtOH Conc. | Freezing Point, | | Flash Point, |
|---|---|---|---|
| Vol. % (Wt.) | F. (C.) | | (TCC) F. (C.) |
| 0 (0) | 32 | (0) | No Flash |
| 10 (8) | 25 | (−4) | 135 (57) |
| 20 (17) | 15 | (−9) | 105 (41) |
| 30 (26) | 5 | (−15) | 90 (32) |
| 40 (34) | −10 | (−23) | 80 (27) |
| 50 (44) | −25 | (−32) | 80 (27) |
| 60 (54) | −35 | (−37) | 80 (27) |
| 70 (65) | *−55 | (−48) | 80 (27) |
| 80 (76) | *−75 | (−59) | 75 (24) |
| 90 (88) | *−110 | (<−73) | 65 (18) |
| 100 (100) | *−175 | (<−73) | 55 (13) |

Isopropanol/Water Mixtures

| IPA Conc. | Freezing Point, | | Flash Point, |
|---|---|---|---|
| Vol. % (Wt.) | F. (C.) | | (TCC) F. (C.) |
| 0 (0) | 32 | (0) | No Flash |
| 10 (8) | 25 | (−4) | 105 (41) |
| 20 (17) | 20 | (−7) | 85 (29) |
| 30 (26) | 5 | (−15) | 75 (24) |
| 40 (34) | 0 | (−18) | 70 (21) |
| 50 (44) | −5 | (−21) | 65 (18) |
| 60 (54) | −10 | (−23) | 65 (18) |
| 70 (65) | −20 | (−29) | 65 (18) |
| 80 (76) | *−35 | (−37) | 65 (18) |
| 90 (88) | *−70 | (−57) | 65 (18) |
| 100 (100) | *−130 | (<−73) | 53 (12) |

The flash point for methanol, ethanol and isopropanol is 13, 13 and 12 Celsius respectively. N-propanol has a flash point of 23 degrees Celsius. Thus, these are highly flammable. However, when diluted with water to around 20 to 30 percent, the flash point is reduced to between 30 to 40 degrees Celsius (for methanol or ethanol). These flash points are comparable to that of white spirits, which has a flash point of below 35 Celsius. N-propanol requires very little dilution with water to bring it into an acceptable flammability range. Thus the precautions required for water/alcohol mixes will be comparable to white spirits. Solvent combinations according to this invention that use water plus compounds such as methanol, ethanol, isoproponal, N-propanol etc., can thus be used in a manner similar to LOSP solvents.

When suitable ratios of ethanol to water are used a range of biocides can be incorporated into stable solutions. The ratio of water:solvent (e.g. ethanol) is most preferably 4:96 or more. Ratios of at least 50:50 or at least 20:80 or 25:75 can also be used. A preferable ratio is 25:75 or 50:50 but this will depend to some extent on the solubilities of the biocides used. These include biocides typically otherwise used in water based systems and which cannot be used in current LOSP processes. For example, more recently developed preservative formulations such as ammoniacal copper quaternaries, copper azole and many borate esters are soluble in water. However, the inventors are not aware that these have been prior used in water/ethanol mixtures. It is not recommended that copper chrome arsenate (CCA) be used because of the interaction of hexavalent chromium with the alcohol. However in the case of CCA an alternative such as a glycol diether could be used, for example, diethylene glycol dimethyl ether.

Whilst not wishing to be bound by any particular theory, the inventors believe that the invention works through some reduction of water substrate interactions immediately following application. This also facilitates rapid recovery of residual solvent.

The inventors hypothesise that the ability of the water miscible soluble solvent/water (e.g. alcohol/water) solvent system to incorporate a range of biocides into stable solutions may be due to the creation of less polar properties of the solvent system.

It is possible that this effect may be due to the alcohol (e.g. ethanol) or other water miscible volatile solvent attaching to free hydrogen bonds from the water thus creating a shielding effect. The more alcohol used in the system in comparison to the water, the greater the shielding effect. The hypothesis is at least in part based on the teaching of M. Ageno and C. Frontali of the Physics Laboratory, Instituto Superiore De Sanita, Rome, who published a paper in 1967 describing the interaction of water and protic solvents. They concluded that, for example, alcohols produce a variety of compounds with water and at the correct ratio of solvent to water the availability of hydrogen bonding available from the water is substantially reduced. This means the “compounds” produced a significantly less polar. Application of this hypothesis to the creation of solvent systems for use in wood treatment may explain how the systems according to the invention achieve their effect. More work is needed to finally determine this however.

The inventors contend that the reduction in flash point may also be created by the chemical interaction and bonding between various molecules of water and alcohol as proposed by Ageno and Frontali. This bonding may also result in a depressed vapour pressure which could have similar benefits.

However truly inorganic biocide systems such as, for example, copper arsenate, have very low solubility in ethanol or ethanol/water mixtures (or other water miscible volatile). Thus it can be anticipated that such systems will be unstable resulting in precipitation of inorganic salts.

Equally significant the compounds otherwise considered soluble in LOSP systems such as the triazoles (hexaconazole, tebuconazole, propiconazole and mixtures thereof being examples), or synthetic pyrethroids, are also soluble in ethanol/water mixes depending on the ratios of the solvent components. Such ratios would be determinable by the skilled person. In addition biocide/solvent properties can be altered by addition of for example, acids. These are known to increase the solubility of nitrogen containing organic biocides. Thus, although solubility is enhanced by addition of an acid this effect is reversed when the acidity is reduced by an increase in pH. Wood is a substrate which buffers at pH 4 to 5, and can allow for an additional fixation mechanism, namely an increase of pH by the substrate itself.

The inventors postulate that these solvent combinations are “universal” solvents allowing the lumber treater to select a biocide or biocide combination of choice to suit the particular hazard exposure desired, that is an organic, an inorganic or a combination organic/inorganic biocide system, or add other components which might change physical properties, for example the likes of phenolic resins, thus significantly expanding choice.

When very high ratios of alcohol to water are used certain biocide systems become less stable for example the inorganic biocides. Similarly the organic biocides might be less stable at low alcohol to water ratios.

In some instances the need for higher alcohol concentrations might be advantageous. For example one might use more ethanolic solutions of triazoles to achieve a specific requirement. Whilst one versed in the art might treat dry wood (wood below say 15 percent moisture content) more than adequately, one might also treat wood at fibre saturation, and by a solvent extraction process, allow the alcohol to reduce the final moisture content to a range which meets final specification, for example below 20 percent moisture content. The residual solvent may be allowed to evaporate from the substrate. This latter process can be enhanced physically and economically by solvent recovery and more particularly by solvent recovery assisted by RF energy. The emitted solvent can then be recovered by vacuum condensation or like techniques as would be known.

In a more specific case, that is when the solvent systems of this invention are combined with the art taught in WO 2004/054765 residual energy retained in the lumber would enable solvent recovery by simple vacuum evacuation.

It is preferable that the composition is applied to the substrate using vacuum impregnation, (e.g. single vacuum), following which the solvent is allowed to evaporate from the substrate, however many variations of vacuum pressure schedules can be used. These are well known to those versed in the art. Solvent recovery can be can be encouraged using RF energy with recovery by condensation techniques. Use of RF energy is preferred when the substrate includes water in addition to solvent. A typical example is where RF energy is applied concurrently with an applied vacuum, thus lowering the boiling point of the solvent system and thus facilitating solvent removal.

The composition can also include other components such as dyes, pigments, water repellents, fire retardants and the like as might be desired in use.

### EXAMPLES

The invention will now be further described with reference to the following non-limiting examples.

Using the principles described in the invention, the inventors set out to study whether the invention was applicable to preparation of stable compositions of biocides wherein water and volatile organic solvent are used in combination.

### Example 1

A solution containing 83% m/m triethanolamine borate was prepared in water. Various samples were diluted with either ethanol, water or a range of water/ethanol mixtures. The inventors found that in all proportions stable fully miscible solutions were produced.

### Table 1 Illustrates This Stability Window

| Active | Water in water - ethanol mix (total formulation) % | | | | |
|---|---|---|---|---|---|
| ingredient | 100 | 75 | 50 | 28 | 25 |
| Triethanolamine | Stable | Stable | Stable | Stable | Stable |
| borate | solution | solution | solution | solution | solution |

It is known that neutralised boric acid salts such as triethanolamine borate are not volatile at ambient or slightly elevated temperatures. Therefore in one aspect of this invention where an opportunity to recover solvent using vacuum or RF assisted vacuum is utilised, this can be successfully carried out because the boron compound selected is not volatile.

Samples of kiln dried pinus radiata were planer gauged to 45 mm by 90 mm cross section. Specific examples were selected of flat sawn material that is with the growth rings across the largest flat face. Samples were cut to length and end sealed with two coats of acrylic paint.

25 percent m/m solutions of triethanolamine borate were prepared in water and 50:50 water ethanol mixes.

### Example 1a

The end coated samples were treated by applying a vacuum of −85 kPa for 5 minutes, then flooding with the preservative fluid and releasing the vacuum. After 30 seconds the fluid was removed.

### Example 1b

A similar schedule was tried wherein a vacuum of −85 kPa was applied, the substrate and chamber flooded with treating fluid and the vacuum lowered to −70 kPa. The excess fluid was then removed and the vacuum completely released.

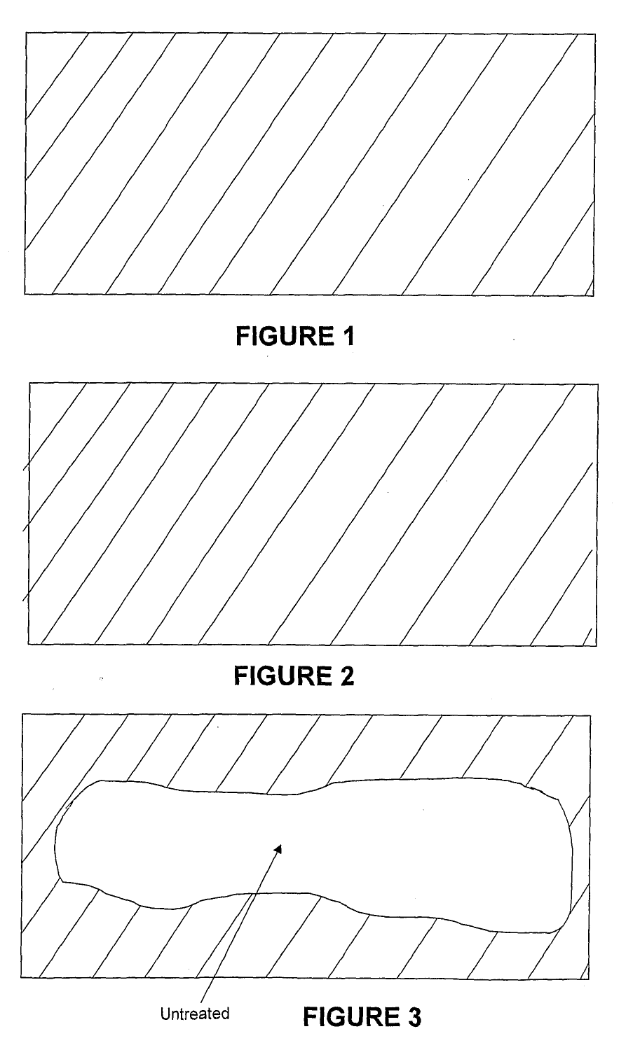

In both methods above samples treated with preservative in ethanol or 60:50 ethanol water mixtures gave complete penetration (see FIGS. 1 and 2). However preservative in water alone only penetrated one third of the distance into the sample as shown in FIG. 3.

It was determined that the samples of example 1a have an uptake of 48 litres per cubic metre and 1b having an uptake of 28 litres per cubic metre.

Most significantly the total uptake in the above examples could be less than 30 litres per cubic metre and yet achieve full penetration. Thus one can see that water can be included in such a fluid without undue rewetting of the substrate.

The inventors have found that the uptake can be altered by variations in the vacuum or partial vacuum used, the flooding time and also the final vacuum, if used.

An important commercial outcome is that when water/ethanol mixes are used, the target preservation performance can be achieved with as little as 5 to 10 litres of ethanol per cubic metre and costing around $10 per cubic metre. This compares very favourably with the cost normally encountered with LOSP where at least 30 litres per cubic metre are required costing more than $30. That is solvent cost can be reduced by over 60 percent.

### Example 2

Solutions were prepared containing the alkaline copper quaternary ammonium compound preservative (ACQ). This preservative contains the active ingredients copper (as an ammonia or amine chelate) and quaternary ammonium salt, in this case didecyldimethylammonium chloride.

When prepared as water/alcohol mixes, the inventors found that stability depended on the final active ingredient content, that is, when the concentration of active ingredients is high the composition is less tolerant of high alcohol content, whereas when the active content was lower higher alcohol concentrations could be tolerated. However, when the amine ligand included an alkanolamine, stability was substantially enhanced.

To achieve out of ground contact specification it is required that ACQ is incorporated in the substrate at around 1 to 2 kg per cubic metre. When applied by normal treatment processes, for example, those conveying from 200 litres per cubic metre to as high as 600 litres per cubic metre, ACQ can be diluted to 1% to 5% using water to achieve suitable retentions within the substrate. ACQ has not hereto been used in processes requiring less than 140 litres per cubic metre whilst effecting substantial depth of penetration.

Thus if a low liquid retention of say 140 litres or less is required, the ACQ concentrate must be diluted by 50 percent only. The inventors have found that when using water/alcohol mixes and such highly concentrated compositions; it is preferable that the water content of the final composition should not be below 25 percent otherwise precipitation of the inorganic components will result when using ammonia based ACQ compositions. However such precipitation does not occur when using alcoholamine compounds instead of ammonia.

Whilst ACQ typically contains 8% active ingredients expressed as cupric oxide and didecyldimethylammonium chloride, other components such as ammonia, amines and carbonate contribute such as the total dissolved solids amount to 20 percent or more.

Thus when 4 kg of active ingredient is required to be impregnated in a low liquid retention the total dissolved solids will be 10 percent. This will exceed the solubility in water alcohol mixes if the alcohol concentration is too high. However when higher liquid retention can be tolerated and the 4 kg active ingredient dissolved in say 300 to 400 litres, higher alcohol concentrations can also be tolerated.

Surprisingly the inventors also found that the level of stability was dependent on the complexing agent used to complex the copper in solution. The traditional complexing agent is ammonia but inclusion of this did not result in highly stable solutions in ethanol or ethanol-water mixtures. However inclusion of the likes of monoethanolamine, diethanolamine or triethanolamine or normal or isopropanolamine resulted in surprisingly stable solutions under otherwise similar conditions. Those versed in the art will recognise a complexing agent as contributing one or more ligands to the metal moiety, in this case copper.

The invention is therefore also directed to a composition combining water, a volatile water soluble organic solvent (such as ethanol), copper and a copper complexing agent selected from alkanolamines (e.g. monoethanolamine, diethanolamine, triethanolamine propanolamine or isopropanolamine).

Table 2 illustrates these findings.

TABLE 2

| Active | Water in water - ethanol mix (total formulation) % | | | | | |
|---|---|---|---|---|---|---|
| ingredient | 100 | 75 | 50 | 28 | 25 | 4 |
| ACQ 50% | Stable | Un- | Un- | Un- | Un- | Un- |
| Ammonia | solution | stable | stable | stable | stable | stable |
| based | | | | | | |
| ACQ 25% | Stable | Un- | Un- | Un- | Un- | Un- |
| Ammonia | solution | stable | stable | stable | stable | stable |
| based | | | | | | |
| ACQ 50% | Stable | Stable | Stable | Stable | Stable | Stable |
| ethanolamine | solution | solution | solution | solution | solution | solution |
| based | | | | | | |
| ACQ 25% | Stable | Stable | Stable | Stable | Stable | Stable |
| Ethanolamine | solution | solution | solution | solution | solution | solution |
| based | | | | | | |

The inventors have also prepared stable solutions of ethanolamine based ACQ in ethylene glycol and propylene glycol and found that combinations could be used where required, for example, or when using such as ethanol as a co-solvent with a ketone such as methyl ethyl ketone.

By ethanolamine based the inventors imply that at least one ligand on the copper atom will be ethanolamine. Those versed in the art will recognise that more than one and up to four ligands can be ethanolamine, but where one, two or three ligands are ethanolamine, the other may be ammonia. This applies to the range of alkanolamines described and can include mixtures thereof.

### Example 3

Solutions were prepared containing 10% Tebuconazole, 10% Propiconazole and 5% Permethrin dissolved in propylene glycol. A portion was diluted in 75 percent ethanol, 25 percent water mixture. The resulting fluid was a transparent readily useable liquid.

### Example 4

To demonstrate the efficacy of recovery of solvent from such a treatment process, the inventors treated a number of specimens of Pinus radiata lumber with an ACQ preservative but wherein the traditional water only solvent had been replaced by a 75:25 ethanol:water mixture. The uptakes and penetration of the preservative was measured and the solvent then recovered by RF assisted vacuum recovery. The recovery was carried out by applying a vacuum of −85 kPa for 15 minutes whilst intermittently applying RF energy at 2.45 GHz. Total energy amounted to approximately 65 kWh per cubic metre. The following table illustrates the uptakes and the recovery efficiency.

| Specimen | Uptake (L/m³ | Solvent recovery % |
|---|---|---|
| 1 | 138.39 | 93.87 |
| 1a | 159.14 | 91.91 |
| 2 | 212.18 | 72.20 |
| 3 | 131.34 | 85.76 |
| 3a | 101.97 | 98.39 |
| 4 | 102.54 | 96.59 |

Thus it can be seen that penetration of the lumber can be achieved by use of this novel solvent system and it also clearly demonstrates that the solvent can be economically recovered for reuse, thus reducing the overall chemical cost.

### Example 5

Commercial sized packets of planer gauged kiln dried lumber were treated with an ACQ type formulation in a solvent comprising water:ethanol of ratio 25:75 using a modified treatment schedule.

All pieces were weighed and the cross section measured prior and subsequent to treatment. The specimens were then subject to an RF energy vacuum recovery schedule.

Subsequent to the completion of the processes it was found that all cross sections were within normal limits that is residual swelling had not occurred, and that 88 percent of the applied fluid had been removed from the wood and recovered.

### Example 6

The sodium salt of bisethylene glycol spiroboronate is a product known in commerce under many brand names including Boracol and is prepared by dissolving disodium octaborate or the equivalent thereof in ethylene glycol. It can contain some water.

A solution of this product was prepared using a solvent system containing a mix of ethanol and water as in Example 1.

Wood samples were treated as in Example 1 and cross sections spot tested. Distribution of the boron component was found to be similar to that of the triethanolamine borate.

This composition was subject to RF vacuum assisted solvent recovery with approximately 95% recovery of the solvent combination.

### Example 7

Example 6 was repeated using an aqueous solvent system containing primarily water (50% water) and whilst uptakes were somewhat higher, RF vacuum assisted solvent recovery provided a wood product of acceptable properties.

Those versed in the art will recognise the benefit of the solvent system of this invention. If one were to apply RF energy to lumber treated with a Stoddard solvent, energy will be absorbed preferentially by bound water in the wood, because Stoddard solvent has a low dielectric loss. This energy will in part transfer from the water to the Stoddard solvent but because the latter has a high boiling point, water will preferentially be removed from the lumber. The wood may therefore be over dried and this can cause shrinkage, checking, and can cause degradation in appearance.

Because the aqueous solvent system of this aspect of the invention includes water, the final moisture content of the treated lumber can be kept in balance. In fact whilst it would be expected that swelling would occur, the inventors have found that lumber treated with this aqueous solvent system, and from which solvent is recovered using RF vacuum assisted solvent recovery; is practically identical to that lumber prior to treatment.

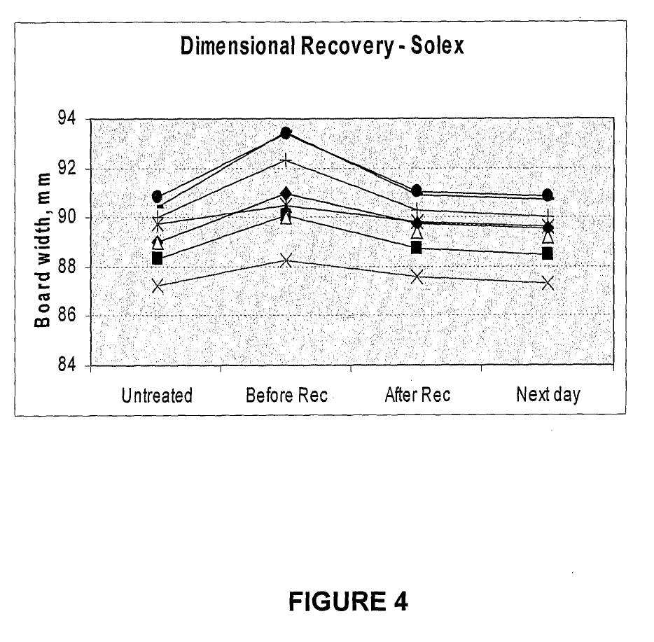

Details of this swell recovery over a range of board widths is shown in FIG. 4.

The aqueous solvent system in this case was ethanol:water 50%:50%. It is expected that swell recovery will occur over a range of volatile water miscible solvent (ethanol):water ratios as would be known to a skilled person once in possession of the invention disclosed herein.

The inventors proceeded to take lumber treated by the process of this invention and by application of the solvent recovery process remove further moisture from the lumber. Initially this was done using samples from the above table (i.e. as in FIG. 4), that is, the samples were subject to reapplication of RF energy and vacuum. By addition of little further energy the moisture content could be reduced below the original moisture content.

### Example 8

It has surprisingly been found that swell recovery is acceptable when the composition includes the use of water only as the solvent when solvent recovery is via RF vacuum, which forms another inventive aspect of this invention.

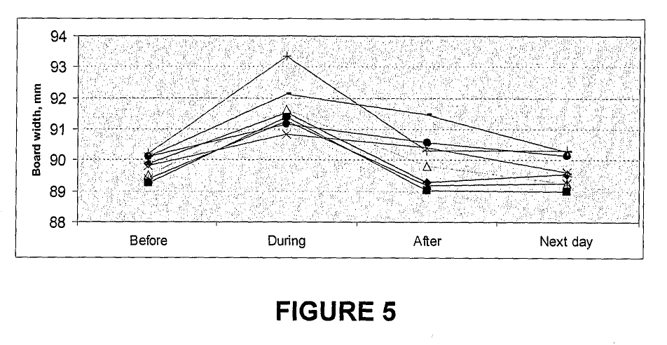

To demonstrate the efficacy of recovery of solvent from such a treatment process but using water alone, the inventors treated a number of specimens of Pinus radiata lumber with an ACQ preservative as for Example 4. The uptakes and penetration of the preservative was measured and the solvent then recovered by RF assisted vacuum recovery. The recovery was carried out by applying a vacuum of −85 kPa for 60 minutes whilst intermittently applying RF energy at 15 MHz. Total energy amounted to approximately 65 kWh per cubic metre. The solvent was removed efficiently and swell recovered to the original dimension as the chart shows in FIG. 5.

Complete sapwood penetration was obtained.

### Example 9

To demonstrate the use of alternate solvents for the process, an ACQ preservative solution was prepared as for Example 4 but where the traditional water only solvent had been replaced with

a) acetone to 65 percent of the total solution volume.
b) 1-propanol to 65 percent of the total solution volume.

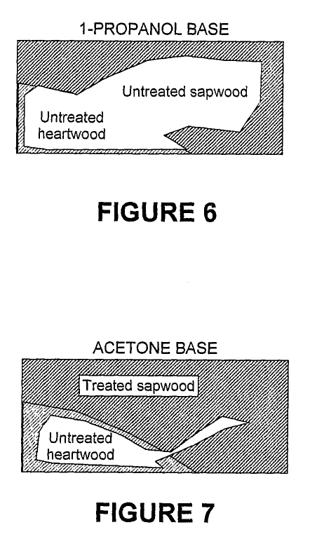

Net solution uptakes by impregnation were 182 L/m3 for the acetone modified solution and 109 L/m3 for the propanol modified solution. The solvent was then removed by RF and vacuum assisted extraction as in Example 8. Net dimensional change was within 0.5% of original size. Examples of preservative penetration are as depicted in FIGS. 6 and 7.

The inventors proceeded to take lumber treated by the process of this invention and by application of the solvent recovery process remove further moisture from the lumber. Initially this was done using samples from the above table (i.e. as in FIG. 4), that is, the samples were subject to reapplication of RF energy and vacuum. By addition of little further energy the moisture content could be reduced below the original moisture content.

As shown in Example 8, it has surprisingly been found that swell recovery is acceptable when the composition includes the use of water only as the solvent when solvent recovery is via RF vacuum, which forms another inventive aspect of this invention.

Use of a “water only” option would be beneficial because it eliminates the use of flammable solvents and reduces costs. However, it takes more energy (and hence more cost) to remove the water from wood. When attempting this, it is commonly found that variable wood moisture content results that contributes to wood degradation and/or variable swell profile.

It would thus be beneficial if a method that allows use of a water-only solvent (together with preferably a water soluble treatment compound) to be provided. As indicated in Example 8, this is achievable if RF assisted vacuum recovery techniques are used. That this can be achieved is surprising as it would be not be expected, based on the use of other recovery techniques, that an adequate result could be achieved.

When one is aware that the cost of drying below fibre saturation can be in the order of $30 to $40 per cubic metre, applying solvent recovery to the process of this invention offers a substantial cost saving in that energy costs are around $10 to $15 per cubic metre. As a further benefit the lumber is more uniformly dry and less stress is created within the lumber.

Thus application of this invention can provide lumber originally at or above fibre saturation that is treated and dried in a single process.

As an additional surprise the inventors noticed that, when lumber had been treated with a timber treatment composition (e.g. ACQ), using the present invention, fluid finally egressing from the lumber toward the end of the recovery and/or redrying process was effectively free of copper. This means that whilst the solvent recovery process was occurring, fixation of the preservative in the timber was occurring concurrently. This is a surprising but beneficial aspect of the solvent system and the solvent recovery process.

Whereas fixation might normally take one hour or longer at 60 Celsius, the recovery of solvent by this invention has occurred within 15 minutes whilst fixation has occurred efficiently in the same time. This is a fourfold increase in fixation allowing more speedy and efficient processing times. Thus the use of a solvent recovery process that increases the temperature in the substrate is preferred due to an improvement of fixation of the biocide in the solvent system. Typical temperatures can be in the order of 40 to 70 Celsius.

The benefits of this process and composition are that treatment can be achieved with either traditional waterborne or LOSP type preservatives using the same solvent system. The solvent can be economically recovered for reuse, lumber moisture content can be reduced economically without causation of undue stress in the lumber, and concurrently fixation of the preservative can be achieved. This entire process can be undertaken in the same treatment vessel thus reducing additional handling costs.

Thus it can be seen that the inventors have discovered a solvent system including combinations which achieve economical and complete treatment of substrates and yet enables the user to use volatile and recoverable solvents. During this process additional drying and/or fixation of the chemical within the substrate can be achieved. The key benefits over either waterborne systems or fully non-polar systems, is a reduction in cost without the concerns for significant rewetting of the substrate. Concurrently it can be seen that the novel solvent system has raised the flash point of an otherwise highly flammable solvent to the same level as those solvents used and readily accepted by processors using the LOSP system. Thus the user is not disadvantaged in his choice. The inventors have also discovered that, when using RF vacuum assisted solvent recovery, water or an aqueous solvent system containing primarily water together with a volatile water miscible solvent can also be used with acceptable results.

Where, in the foregoing description, reference has been made to components have known equivalents, then such equivalents are incorporated herein as if individually set forth.

Reference to prior art documents and disclosures does not constitute an admission that these are necessarily common general knowledge in any particular jurisdiction.

Although the invention has been described by way of example with reference to a preferred embodiment, modifications and variations may be made to the invention without departing from the scope or spirit of the invention as defined in the attached claims.

1-98. (canceled)

99. A process for treatment of an organic substrate, the process including the steps of:
(a) applying an organic substrate treatment composition to the organic substrate, the composition including water, a volatile water miscible solvent, and an organic substrate treatment compound, wherein either the volatile water miscible solvent or its combination with water is capable of absorbing RF energy; and
(b) recovering either the solvent alone or the water and solvent by RF energy supplemented vacuum condensation.

100. The process according to claim 99 wherein the volatile water miscible solvent has a high dielectric loss.

101. The process according to claim 99, wherein the organic substrate treatment compound is non-volatile.

102. The process according to claim 99, wherein the substrate has a temperature above ambient during solvent recovery.

103. The process according to claim 99, wherein the organic substrate is lignocellulosic.

104. The process according to claim 99, wherein the volatile water miscible solvent is a low molecular weight alcohol, ketone, ether or diether.

105. The process according to claim 99, wherein the volatile water miscible solvent is selected from the group consisting of a Stoddard solvent, methanol, ethanol, ethyleneglycol monomethyl ether, ethylene glycol dimethyl ether or diethylene glycol dimethyl ether, DMSO, N-methyl pyrrolidone, ethylene glycol, propylene glycol, or glycerol.

106. The process according to claim 99, wherein the ratio of water:solvent is at about 4:96 to about 50:50.

107. The process according to claim 99, wherein the organic substrate treatment compound is a biocide.

108. The process according to claim 99, wherein the organic substrate treatment compound alters the physical properties of the substrate.

109. The process according to claim 108, wherein the organic substrate treatment compound is selected from resins or polymers or components which can become resins or polymers.

110. The process according to claim 99, wherein the organic substrate treatment composition further includes dyes, pigments, water repellents, and/or fire retardants.

111. The process according to claim 99, wherein the organic substrate treatment compound is an amine copper complex.

112. The process according to claim 111, wherein the amine copper complex is formed using an alkanolamine as the amine complexing agent.

113. The process according to claim 112, wherein the alkanolamine is monoethanolamine, diethanolamine, triethanolamine or propanolamine.

114. The process according to claim 99, wherein the organic substrate treatment compound contains a copper compound, a quaternary ammonium compound, or a combination thereof.

115. The process according to claim 99, wherein the organic substrate treatment compound is a copper complex formed from a copper compound and an alkanolamine, and the copper compound and alkanolamine are dissolved in ethylene or propylene glycol.

116. The process according to claim 99, wherein the organic substrate treatment compound is an azole, a mixture of azoles, or a mixture of azoles and an amine copper complex.

117. The process according to claim 99, wherein the organic substrate treatment compound is a borate compound or triethanolamine borate.

118. The process according to claim 99, wherein the organic substrate treatment compound is any one or more of propiconazole, tebuconazole, and permethrin, dissolved in a glycol.

119. The process according to claim 99, wherein the organic substrate treatment compound is a salt of a glycol spiroboronate or a salt of ethylene glycol spiroboronate.

120. The process according to claim 99, wherein the organic substrate is substantially dry lumber.

121. The process according to claim 99, wherein the composition includes a fire retardant.

122. The process according to claim 121 wherein the fire retardant is in combination with a biocide.

123. A treated organic substrate prepared by the process according to claim 1.

124. An organic substrate treatment composition, comprising water, a volatile water miscible solvent, and an organic substrate treatment compound; wherein the volatile water miscible solvent or its combination with water is capable of absorbing RF energy.
